(19) United States
(12) Patent Application Publication
(10) Pub. No.: US 2016/0332927 A1
(43) Pub. Date: Nov. 17, 2016

(54) AERATION BED AND COMPOSTING SYSTEM

(71) Applicant: Henricus Theodorus HOFSTEDE, Osborne Park, Western Australia (AU)

(72) Inventor: Henricus Theodorus HOFSTEDE, Osborne Park, Western Australia (AU)

(21) Appl. No.: 15/112,047

(22) PCT Filed: Jan. 19, 2015
(86) PCT No.: PCT/AU2015/050016

§ 371 Date: Jul. 15, 2016

(30) Foreign Application Priority Data
Jan. 17, 2014 (AU) 2014900149

(51) Int. Cl. C05F 17/02

(52) U.S. Cl. CPC C05F 17/027; C05F 17/0294

(57) ABSTRACT

An aeration bed and composting system for aerating and/or drying of organic matter, materials or biomass to facilitate at least one stage or phase of a composting process. The composting system facilitates ready removal of useable portions of compost following completion of phases of the composting process. The composting system includes a holding area for holding a quantity of compostable material. The holding area has a base with at least one permeable portion. At least one chamber is located below the holding area. The chamber has an inlet to direct oxygen-containing fluid into the chamber and an outlet for directing matter outwardly from the chamber. An opening of the outlet is disposed lower in the chamber relative to an opening of the inlet. Creation of positive pressure within the chamber drives air upwardly through the permeable portion of the base of the holding area and into the compostable material.

### FIELD OF THE INVENTION

The present invention relates to arrangements and components for aeration and/or drying of organic matter, materials or biomass.

In particular, the present invention relates to an aeration bed and composting system for treatment of organic matter or biomass.

### BACKGROUND TO THE INVENTION

It is well known that large amounts of domestic waste are produced on a daily basis, a significant proportion of which is organic in nature. Whilst one traditional method of waste disposal involves landfill, simply putting organic waste into landfill without first treating it can have detrimental effects, particularly since decomposing organic matter can produce undesirable gases and odours.

Fortunately, organic waste has potential use as a resource when it is appropriately treated. There have been many endeavours to treat organic waste to produce a useful resource and one such method of treatment is by composting. In composting, organic material is typically placed in a heap or in a vessel wherein natural or introduced microbes degrade or decompose the organic matter using oxygen.

Composting is a process that is suitable for treatment of most combinations of organic waste, including green waste, food waste, sewage sludge and commercial organic residues. Composting has advantages in that it is a generally environmentally friendly way of treating organic waste that produces material having useful properties. For example, mature compost has application as and offers significant benefits as a soil conditioner.

In any typical composting process, large complex molecules of organic biomaterial are broken down by a variety of microbes to form simple, stable molecules which make up the humus-like matrix of nutrients and organic matter commonly referred to as compost. It is important, to ensure quality and usefulness of the final compost product, that the organic material be sufficiently broken down or matured. This requires appropriate oxygen and moisture levels and a suitable temperature range. However the requirements of each may vary at different stages of the composting process.

Many of the microorganisms involved in the composting process, particularly in the early phase of the process, thrive at a temperature within the range of about 25° C. to 45° C. Microbial activity and the resulting exothermic decomposition process, together with insulating properties of the organic material itself, generally causes temperature of a heap of composting biomass to rise. The temperature can be caused to further rise by activity of thermophilic bacteria, whereby temperature of some parts, particularly the centre, of the composting heap, can rise up to 70° C. or even higher.

Whilst some rise in temperature is beneficial, so as to for example, initiate a thermophilic phase of composting where organic matter is decomposed quickly, such significant rises in temperature are undesirable as excessive temperature can kill some microbes beneficial to the composting process. Ideally, temperature range of most, if not all of the compost heap should be about 45° C.-60° C.

It is also of importance to the composting process that the microorganisms involved in decomposition have sufficient oxygen. Microbial oxygen demand is high during composting and aeration of the mass is generally required if the process is to have any degree of efficiency.

Once levels of organic matter to feed the composting process and maintain temperatures between 45° C.-60° C., temperatures can fall. A final stage in the composting process is maturation of the organic material to ensure that the resulting material is beneficial to plants and is substantially free of toxic components.

The heap of organic material is typically covered during most, if not all of the composting process and this can assist in retaining moisture and heat. However, covering of the heap can also contribute to increasing the temperature to levels that are detrimental to microbial activity. Further, if the heap is relatively large, it can be difficult to achieve aeration of especially the innermost portion of the heap. Mixing of the organic matter is one possible solution to assist with temperature and aeration, but this either requires machinery or manual labour in order to do so. Further, mixing alone is unable to address the temperature and aeration needs of each respective stage of the composting process.

It is advantageous to attain as uniform as possible aeration and temperature distribution throughout the organic matter, not only to promote optimal and appropriate microbial activity, but to ensure adequate eradication of pathogens. Attempts have been made in the past to remedy difficulties in attaining even temperature and aeration throughout a heap of organic material. One such attempt is provision of a single point application of air, consisting essentially of a pipe located centrally of the heap of organic matter, the pipe being arranged to introduce air into the heap. This can be used with or without a cover over the organic matter. However, such an arrangement is still unable to effectively achieve uniform temperature and aeration. Temperature in particular can be problematic as the innermost portion of the organic matter heap can attain temperatures suitable for pathogen eradication, however, outermost portions can often fail to reach adequate temperature. There is then a very real risk that portions of organic matter which still has pathogens present can reinfect those portions previously sterilised with high temperature.

On completion of the composting process, manual or machine intervention is typically required to extract useful product from the compost heap. For example, an entire heap may simply be removed after a certain period of time and replaced with new organic material. However, this does not typically take into account that different portions of the heap may be at different stages of the composting process, a problem that is typical if temperature and aeration has not been uniform throughout the material during composting. This may lead to removal and application of compost that is not yet mature, thereby risking application of matter that may have toxicity to plants or which may not be effectively utilised by plants.

A further problem that is experienced particularly in composting of static heaps of compostable material is that excess water in the material, such as from excessive rainfall, may interrupt the composting process by changing conditions from a composting process to a rotting process. Further, excessive water in a compostable heap can lead to leach generation, where undesirable components can be leached as potential pollutants and saleable nutrient material can be lost.

There is therefore room for improvement in achieving adequate aeration, moisture and/or temperature control and distribution in composting of organic matter, as well as in extraction of material that has progressed sufficiently to a mature and useful compost.

The present invention aims to provide improvements to these aspects of the composting process.

### SUMMARY OF THE INVENTION

With the aforementioned in mind, the present invention seeks to provide a composting system that facilitates at least one stage or phase of a composting process in an efficient manner and under conditions that assist optimisation of the composting process.

In addition, the present invention seeks to provide a composting system that facilitates ready removal or extraction of mature or useable portions of compost, following appropriate completion of the respective phases of the composting process.

With the aforementioned in view, the present invention provides in a first aspect, a composting system including:
a) a holding area for holding a quantity of compostable material, the holding area having a base with at least one permeable portion;
b) at least one chamber located below the holding area;
c) an inlet to direct oxygen-containing fluid into the chamber; and
d) an outlet for directing matter outwardly from the chamber, wherein an opening of the outlet is disposed lower in the chamber relative to an opening of the inlet.

Aeration is important to conduct and complete the composting process since it provides the oxygen necessary to sustain aerobic organisms that are essential to the composting process. In a static pile of organic compostable material, such as a heap placed into the holding area, oxygen levels will soon fall to levels inhibitive to composting. The composting system therefore additionally includes an aerating means or air supply system for providing and directing oxygen-containing gas, typically air, to the inlet and into the chamber.

The aerating means can provide the air into the inlet via a conduit or other suitable channel. Preferably, the aerating means provides the air into the conduit and hence the chamber under pressure, so as to create a positive pressure in the chamber when there is a heap of compostable material in the holding area.

Airflow into the inlet can be maintained by a suitable air distribution system including a blower which can also regulate air flow as necessary. The air distribution system may optionally provide airflow into two or more inlets, opening into the chamber.

Creation of a positive pressure within the chamber drives air upwardly through the at least one permeable portion of the base of the holding area and upwardly into the static heap of compostable material. Desirably, the base has two or more permeable portions. In an alternative embodiment, the entire base can be permeable.

Advantageously, air is driven upwardly substantially uniformly through the one ore more permeable portion of the base, thereby driving air upwardly into substantially the entirety of the base of the heap, maximising air penetration of the heap.

Further, the creation of the positive pressure in the chamber serves to drive the air into the heap more than a nominal distance. Depending on the pressure applied, air can be driven substantially towards the top of and into the centre of the heap, thereby providing the entire heap with sufficient oxygen to meet microbial demands and ensure that microbial composting activity is optimised.

The permeable base of the holding area permits flow of the air from the chamber and into the heap. A challenge however, is to maintain sufficient fluid (typically oxygen-containing gas) flow through in the permeable base, by keeping it substantially free of solid material that might clog apertures in the base and prevent air flow from the chamber to the heap. The permeable base or permeable portion(s) of the base therefore includes a first mesh portion and a second mesh portion, wherein the first mesh portion overlays the second mesh portion.

The base can be permeable to fluid flow upward through the base, such as a gas flow from the chamber into the material to be composted in the holding area. The permeable base can also be permeable to liquid flow down into the chamber from the composting material. It will be appreciated that the permeable base can also be porous.

The first mesh portion is sufficiently resilient to bear significant portion of the weight of the heap of compostable material when bulk quantities of compostable material is placed in the holding area. The first mesh portion has apertures of a size sufficient to hold the bulk of the organic material of the heap atop the base and prevent solid particles from passing downwardly into the chamber, whilst remaining pervious to liquid and fine particulate matter, which may have substantially completed the composting process. The first mesh portion preferably comprises a reinforced synthetic mesh or stainless steel mesh, such as oyster netting. The first mesh should have strength, resilience and durability to provide support and grip for equipment and mobile machines that may be driven on top or over the holding area.

In order to support weight of equipment and mobile machines driven on top or into the holding area, in a preferred embodiment, the base is reinforced with concrete or other suitable structural material. Part of the base can therefore be composed of concrete, with one or more first and second meshed portions embedded into the concrete portion of the base. Desirably, the mesh portions are located below an upper surface of the concrete portion. That is, the mesh portions are recessed into the concrete portion. In this way, vehicles or equipment are less likely to come into direct contact with the mesh and instead will have their weight supported by concrete portion. This advantageously preserves life of the mesh and inhibits organic material being pushed into the mesh by weight of vehicles or equipment.

The second mesh portion is disposed directly beneath the first mesh portion. The second mesh portion is a sheet of permeable material, such as a synthetic mesh or oyster mesh, having apertures of a size that are smaller relative to apertures of the first mesh portion. The apertures of the second mesh portion are smaller so as to prevent smaller solid particles from passing into the chamber whilst still permitting liquid to pass through. It is preferred that the second mesh portion has properties, including aperture size, which permits adequate flow through of gas and/or liquid. Ideally, apertures of the second mesh portion are of a size less than apertures of the first mesh portion but are greater than about 100 micron, preferably greater than about 105 micron. The first mesh portion atop the second mesh portion assists in preventing the smaller apertures of the second mesh portion from becoming clogged with larger particulate matter and preventing air and liquid flow. The first mesh portion also acts to protect the second mesh portion from structural damage.

The combination of first and second mesh portions advantageously serves to minimise significant quantity or pieces of compostable material from entering into the chamber and potentially blocking the opening to the air inlet. The combination of two layers of mesh having different sized apertures also increases the lifespan of the permeable base, since the permeable base remains pervious to air and liquid for a longer period of time than if the permeable base consisted of a mesh having only single size of apertures.

The permeable base is supported atop the at least one chamber. The permeable base may be at least partially supported by perimeter walls of the at least one chamber. It is preferred that further support is provided to the permeable base to prevent sagging of the mesh of the permeable base, particularly when bulk quantity of compostable material is placed thereon.

In a preferred embodiment, support means, such as in the form of grids or drainage cells, traverse between the permeable base and base of the chamber. The support means ideally have a structure that does not impede airflow into the heap or liquid flow into the chamber. A plurality of support means are ideally spaced apart at substantially regular intervals so as to provide equal load bearing support across the entire permeable base.

Support means may take the form of one or more aerobic drainage cells such as those sold commercially under the Atlantis brand, or other similar grid structure that permits flow of air but offers structural strength, including to the first and second mesh layers. The aerobic drainage cells are placed atop the base of the chamber. In a preferred embodiment, the drainage cells are placed in recess channels formed in the chamber base, conferring additional structural support. The chamber, which is located beneath the permeable base, essentially consists of a pit, preferably below ground level, having walls, a base and an open top, across which the permeable base is located. The composting system may include two or more chambers or pits, with the permeable base traversing an area comparable to the sum total of the open top of all chambers or pits. It is important for purposes of maintaining of aeration of the heap, that the air inlet opening into the chamber does not become blocked with composting material or liquid. The opening of the inlet is therefore advantageously located above the base of the chamber and located higher in the chamber relative to the opening of the outlet. The opening of the inlet can be located in a wall of the chamber or can be located above the base, such as by the conduit from the aerating means extending upwardly from the base towards the permeable base.

The outlet can include a pipe or suitable conduit that opens into the chamber and directs liquid outwardly therefrom. The outlet can take the form of a drainage pipe, preferably having an S-bend or trap so as to prevent air leaking out, so as to maintain the positive pressure conditions within the chamber.

Advantageously, locating the chamber below ground level, with the heap located above, provides convenience whereby improved aeration can be provided to the heap, but keeps much of the components for providing aeration out of the way. As such there is reduced risk of damage from, for example, vehicles delivering compostable material to the holding area or transferring composted material away therefrom.

The heap, located above the chamber is held in the holding area by a wall. The wall permits the heap size and height to be increased, increasing the amount of organic material that can be composted with the present system. The wall can have length and height suitable to meet the needs of the amount of organic material required to be composted. The heap is preferably covered by a weatherproof cover, which may be as simple as a flexible plastic membrane. In a preferred embodiment, the cover is a retractable cover, retractable and extendible along top of the wall to cover substantially the entirety of the holding area. The cover serves to protect the heap from ingress of water or other environmental impacts that may be detrimental to the composting process, such as excessive drying.

The cover also acts to appropriately secure or substantially seal the heap, assisting in retaining the air in the heap as it is distributed through by the aeration bed and prevents escape of significant amounts of air into the atmosphere. The cover can also assist in retaining heat within the heap. Due to the improved and even air distribution throughout the heap in conjunction with the cover, the temperature is also relatively even throughout the heap, typically maintained within the range of about 50-65° C.

The composting system can also include a conduit extending from the heap, through the cover, to the chamber. The conduit is preferably in communication with an extractor/blower so that warm and moist air can be drawn outwardly from the heap to reduce temperature/moisture if necessary. That is, heat and air recoverable from the heap can be recirculated as required by channelling warmed air through the conduit. The conduit can also be utilised to channel additional air into the heap through the cover. Preferably, monitoring means is included to monitor moisture/temperature, whereby air and moisture can be extracted or channelled to the heap as appropriate to maintain the heap at temperature and moisture levels for optimisation of the composting process.

Monitoring means includes monitoring of one or more of temperature, oxygen levels and/or moisture levels. Monitoring means is in communication with data processing unit. Preferably monitoring means communicates with data processing unit remotely and/or wirelessly. Data processing unit is in communication with a controller, which controls valve and blower operation. Data collected and processed by data processing unit is therefore utilised by controller to mix air from the heap with fresh air at suitable ratios to provide optimal conditions within the organic matter to optimise the composting process. It is preferred that monitoring, data collection and processing and control of valve and/or blower operation is automated and is varied automatically as necessary to optimise composting conditions.

The composting system with an aeration bed of the present invention is thus advantageously able to control air and heat distribution within the heap, reducing temperature hotspots and facilitating composting at substantially the same rate throughout the heap. The improved aeration provided by the present invention can advantageously reduce the total time taken to achieve a mature composted product by up to half, primarily due to the improved distribution of air throughout the heap as well as the substantially uniform temperature distribution.

A further aspect of the present invention provides a method of aerating a compostable material, the method including providing a supply of a gas at a pressure above ambient air pressure into a compostable material.

Preferably the gas includes or is air. The gas may be supplied into a chamber below the compostable material and allowed to travel up into the compostable material.

Gas may be returned from the compostable material back into the supply to the compostable material.

Temperature within at least one zone within the compostable material may be controlled by varying or controlling at least one of rate or volume of gas flow through the compostable material, rate or volume of gas flow from and returned to the gas supply, and rate or volume of gas supplied to the compostable material.

Gas flow may be controlled by varying rate or volume of gas supplied for a blower into the chamber and/or varying gas returned to the chamber or compostable material.

In a particularly preferred embodiment of the invention, the composting system includes a second holding area. The second holding area, as per the first holding area, also has a permeable base with at least one chamber located beneath. The permeable base ideally also includes a first and second mesh portion and support means, substantially as per the first holding area. The chamber beneath the second holding area is typically provided with inlet to direct oxygen-containing gas therein, as well as outlet, substantially as per the first chamber. The second holding area, permeable base, chamber and the like collectively comprise a second treatment zone. The second treatment zone finds application in curing of material that has undergone first stage of composting in the first holding area.

In this embodiment, the compostable material is processed in the first holding area for a first period of time, that period of time dictated at least in part by the type and composition of the compostable material. The first period of time is typically in the order of about four weeks. At the end of the first period, the partially treated compostable material is transferred to the second holding area, where it undergoes a second treatment phase for a second period of time, typically in the order of about two weeks.

In this embodiment, spent air from the compostable material in the first holding area which is not recycled through the compostable material and hence would otherwise require discharge, is channelled into the chamber beneath the second holding area. Optionally, fresh air is blended with the spent air before introducing into the second stage compostable material, held in the second holding area. Ratio of spent/fresh air can be varied as necessary by a control means. This action of channelling spent air from the first stage compostable material advantageously removes odorous compounds from the spent air as it passes through the second stage compostable material. That is, the compostable material in the second holding area acts as a filter to remove odour. Advantageously, as well as removing odour, flow of this air through the second phase compostable material provides additional aeration to assist the second stage compostable material progress to saleable product. Spent air from the second treatment phase can be safely released into the ambient environment.

### BRIEF DESCRIPTION OF THE DRAWINGS

The invention may be more fully understood from the following description of non-limiting embodiments thereof, made with reference to the accompanying drawings in which:

FIG. 1 is a cross section view of a composting system with aeration bed in accordance with the present invention;

FIG. 2 is a cross section view of an embodiment of the composting system with means for channelling air and/or moisture to and from the heap for purposes of temperature and moisture control; and

FIG. 3 is a cross section view of a further embodiment of the present invention wherein the composting system includes at least a first and second treatment zone

### DESCRIPTION OF PREFERRED EMBODIMENT

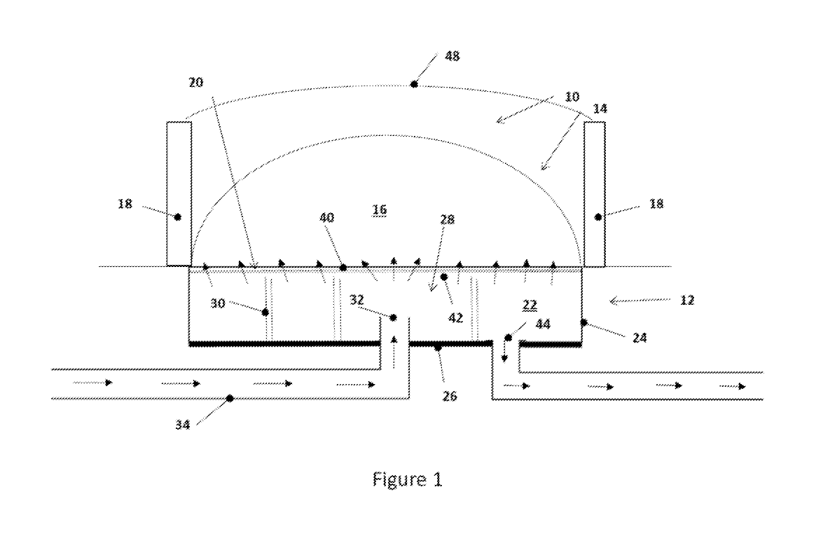

Referring now to FIG. 1, there is shown a cross section of a composting system 10 with an aeration bed 12 for improved aeration of a quantity of compostable organic material. The compostable material can be any organic material or organic waste from domestic or industrial sources, including green waste and biosolids. The composting system 10 includes a holding area 14 for holding the compostable material, usually in the form of a heap 16. The holding area 14 includes a wall 18, substantially surrounding the holding area 14. The wall 18 permits bulk quantities of compostable material to be heaped in the holding area 14 and permits increase of the heap 16 size and height, thereby increasing surface area and volume of the heap 16.

The holding area 14 has a permeable base 20, upon which the heap 16 of compostable material is placed for composting. A chamber 22 is located beneath the permeable base 20. The chamber 22 essentially comprises a below-ground pit, having walls 24, a base or floor 26 and an opening 28 opens up to the holding area 14 substantially at ground level. In one embodiment, the permeable base 20 spans substantially the entire opening 28 of the chamber 22. However, in a further embodiment, the permeable base 20 includes a solid portion comprised of a strong structural material such as concrete, and one or more permeable portions in the base 20. Number of permeable portions depend at least in part on the overall size of the holding area 14. In this embodiment, the chamber 22 is opened up to the holding area 14 only at the permeable portions of the base 20.

In a typical example of this embodiment, the base 20 includes three permeable portions, each extending substantially along the length of the base 20 and of the holding area 14. Each permeable portion is ideally of size and configuration that is at least marginally less than the width of a tyre of typical vehicle that might be driven into the holding area 14. In this arrangement, the vehicle is much more likely to drive over and be supported by solid portion of the base 20 and therefore be much less likely to cause structural damage or reduce effectiveness of permeable portions. Thus, the arrangement of solid portion and permeable portion of the base 20 is such that at least part of the tyre of vehicles or machinery is generally always supported by solid portion of the base 20.

In the embodiment shown in the Figures, the composting system 10 includes a single chamber 22. However, it should be understood that two or more chambers 22 can be provided. In either case, the permeable base 20, consisting of solid portions and permeable portions, spans substantially the entirety of the area of the combined openings 28 of the chambers 22.

The permeable base 20 is at least partially supported atop the chamber 22 by walls 24 of the chamber 22. That is, outermost edges of the permeable base 20 are supported atop the chamber walls 24. However, since the holding area 14 and permeable base 20 are intended to hold significant quantities of compostable material, additional support is desirable to prevent sagging or loss of integrity of the permeable base 20, particularly at the permeable portions of the base 20.

Support means 30, such as in the form of grids or drainage cells, are arranged to traverse between the permeable base 20 and the floor 28 of the chamber 22. Importantly, the support means 30 has a structure that does not impede the porosity or permeability of the permeable base 20. That is, the support means 30 should not impede either air or liquid flow through the permeable base 20. To this effect, the support means 30 may consist of aerobic cells having design structure which provides capacity to support up to about 70 tonnes/m². A suitable example are aerobic drainage cells, such as those offered commercially under the Atlantis brand. However, other similar grid structures with the required strength and durability may also be used. It is desirable also that the support means 30 has porosity or permeability that does not impede airflow throughout the chamber 22.

Ideally, such support means 30 are spaced apart at regular intervals in order to provide load bearing support substantially across the entire permeable base 20 and particularly at the permeable portions of the base 20. Support means 30 are desirably positioned in recess channels (not shown) formed in the floor 28 of the chamber 22. This arrangement provides additional structural support and minimises movement of the support means 30 in the chamber 22.

Provision of support means 30 advantageously provides sufficient strength to the permeable base 20 such that vehicles delivering organic matter to be composted, or removing matured compost can safely drive over the permeable base 20 without causing damage to the composting system 10. In the embodiment where the permeable base 20 consists of solid portion and one or more permeable portions, the support means 30 is particularly useful in supporting the permeable portions.

The permeable base 20, together with the chamber 22 and aerating means, forms an aeration bed 12 to provide improved aeration to the heap 16.

The aerating means includes device or apparatus capable of introducing oxygen-containing gas such as air, into the chamber 22 to create a positive pressure within the chamber 22. One example is a blower, preferably a blower having capacity to regulate air flow and hence control pressure levels within the chamber 22.

Air flow can be regulated by valves or valve arrangement, such as butterfly valve. It is preferred that control of air flow is controlled by a controller (not shown) the controller being in communication with monitoring means and data processing unit. Monitoring means monitors one or more of temperature, moisture and oxygen levels in and around the heap 16 and communicates this data on a regular basis to the data processing unit. The received data is then used so that the controller operates valve to modify and control ratio of fresh air and recycled air being directed into the chamber 22 and into the heap 16.

Fresh air is introduced into the chamber 22 via an inlet 32 having an opening into the chamber 22. The inlet 32 is in communication with the aerating means by a conduit 34 or other suitable channel.

The inlet 32 into the chamber 22 may be disposed in a wall 24 of the chamber 22 or may open through the base 26 of the chamber 22, as is shown in FIG. 1. In this embodiment, the inlet 32 comprises an upwardly extending pipe, wherein the opening of the inlet 32 is located above the base 26 of the chamber 22 and towards the permeable base 20.

In a preferred embodiment, two or more inlets 32 open into the chamber 22. In such an embodiment, it is preferred that each inlet 32 is located so as to maximise air flow into and throughout the chamber 22. As an example, in an arrangement where the base 20 has three permeable portions, each permeable portion extending substantially the length of the holding area 14, a first inlet 32 could be located adjacent a first end of a first permeable portion; a second inlet could be located adjacent a mid point of a middle permeable portion and a third inlet could be located adjacent an opposing end of a third permeable portion.

As air is introduced into the chamber 22, a positive pressure is created in the chamber 22. This pressure drives air upwardly through permeable portions of the permeable base 20 and into the base of the heap 16. Thus, instead of air being driven into the heap 16 at a generally localised point, as is the case with many prior art systems, the creation of the positive pressure serves to drive air upwardly and through pores or apertures substantially across the entire base of the heap 16. Such uniform distribution of air into the base of the heap 16 serves to distribute air evenly through the entire heap 16, thereby providing sufficient oxygen to meet microbial demands throughout the composting process.

Since the permeable base 20 permits flow of air from the chamber 22 and into the heap 16, it is essential that the permeable base 20 maintains sufficient porosity. However, since the permeable base 20 has significant quantities of particulate matter placed thereon, it is a challenge to ensure that apertures or pores in the permeable portions of the permeable base 20 are kept substantially free of solid and particulate matter. Clogging of these pores or apertures will act to prevent air flow from the chamber 22 to the heap 16, thereby disrupting airflow. Similarly, clogging of the permeable base 20 prevents liquid from passing through and into the chamber 22, as will be discussed below.

In order to maintain porosity or permeability of the permeable base 20 for as long as possible and at least until a quantity of compostable material has progressed to mature compost, each permeable portion of the permeable base 20 includes a first mesh portion 40 overlaying a second mesh portion 42. The first and second mesh portions 40, 42 are substantially the same size and are each of size comparable to the or each opening 28 of the chamber 22.

The first mesh portion 40 is provided as a resilient grid or grate, having substantially uniform apertures of size appropriate to hold solid material of the heap 16 atop the base 20 and prevent at least medium to large sized solid particles from falling through. Though supported at least in part by support means 30 as described above, the first mesh portion 40 has sufficient strength and resilience to bear not only the weight of the heap 16 but also resist damage from, for example, vehicles driving over it. The first mesh portion 40 may therefore be comprised of a metal grating or a reinforced synthetic mesh, such as oyster netting. In order to further resist damage from vehicles or equipment driving into the holding area 14, the first mesh portion 40 is ideally recessed into solid portion of the base 20. That is, if the solid portion is a concrete slab, the mesh portion 40 is disposed just below an uppermost surface of the slab.

The second mesh portion 42 is disposed directly beneath the first mesh portion 40 and serves to capture particulate matter that fails through apertures of the first mesh portion 40 whilst permitting air and liquid to pass through. The second mesh portion 42 therefore also has uniformly distributed apertures, but these are smaller relative to the apertures of the first mesh portion 40. The second mesh portion 42 has properties, which includes size of the apertures, which permits flow through of liquid. Aperture size of the second mesh portion 42 is of a size relatively smaller than aperture size of the first mesh portion 40, yet greater than about 100 micron. Ideally, typical aperture size of the second mesh portion is greater than about 105 micron. The combination of first and second mesh portions 40, 42 in this arrangement serves to prevent the smaller apertures of the second mesh portion 42 from becoming clogged quickly with particulate matter from the heap 16. This advantageously extends the working lifespan of the permeable base 20 before the second mesh portion 42 either requires replacing or cleaning to restore permeability.

Liquid may accumulate in the heap 16, either as part of moisture created in the natural progression of the composting process, or due to ingress of water such as from rainfall. Excess liquid can lead to undesirable leaching of immature compost and hence potential pollutants, or uncontrolled loss of nutrients, thereby potentially reducing value of the saleable compost product. In order to minimise or mitigate these effects, an outlet 44 opens into the chamber 22 and extends into a channel or pipe 46 to direct liquid outwardly from the chamber 22. Liquid can be directed outwardly from the chamber 22 essentially by gravity feed. Outflowing liquid can be collected from the outflow and processed appropriately, likely dependent on the particular composition of the outflow liquid.

Importantly, the opening of the outlet 44 is disposed in the chamber 22 lower relative to the opening of the inlet 32. This ensures that liquid and particulate matter in the liquid can be drained away and risk of blocking the inlet 32 and therefore impairing airflow is mitigated. In the embodiment shown in FIG. 1, the outlet 44 is a drain opening in the base 26 of the chamber 22. In a preferred embodiment, the outlet 44 includes a drainage pipe, having either an S-bend or a trap so as to prevent air leaking outwardly through the outlet 44 and thereby reducing the pressure within the chamber 22.

Maintaining pressure in the chamber 22 is important to sustain the uniform distribution of air through the permeable base 20 and into and throughout the heap 16. Once air is distributed upwardly into the heap 16, as well as circulating throughout the heap 16, air can also be lost to the atmosphere. As well as loss of air, the heap 16 can additionally experience loss of moisture and heat through exposure to environment, particularly if the surface area of the heap 16 is relatively large.

One way of mitigating loss of particularly moisture and heat is to provide a cover 48 over the heap 16. The cover 48 takes the form of a flexible, substantially impervious membrane, such as a plastic sheet. In a preferred embodiment, the cover 48 is retractable and extendible along tops of the walls 18 of the holding area 14. The cover 48 serves to substantially seal the heap 16 when extended, not only retaining air introduced by the aerating means and aeration bed 12, but also retaining heat. This heat, produced by the composting process in the heap 16, can be recovered from the heap 16 and can be recirculated by channelling and distributing warmed air from the heap 16 as required. The combination of improved and even air distribution throughout the heap 16, together with this recirculation of air, ensures that temperature of substantially the entirety of the heap can be maintained within an ideal range of about 50-65° C. The cover 48 can be retracted when access is required into the holding area 14, for example to load or remove organic material from the holding area 14.

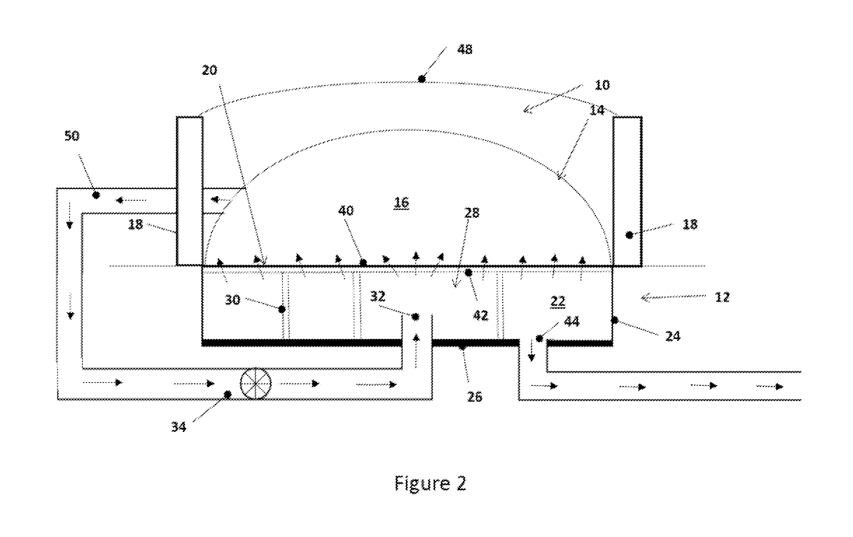

Referring now to FIG. 2, there is shown a further embodiment of the present invention, wherein the composting system 10 has air conditioning means to recover warm air from the heap 16 and distribute the warm air for purposes of controlling air temperature. The air conditioning means includes an air pipe 50, in communication with the heap 16 or area surrounding the heap 16, and the aerating means. In the embodiment shown in FIG. 2, the air pipe 50 extends from an opening in the cover 48 to a blower/exhaust of the aerating means.

As air circulating in and out of the heap 16 becomes warmer and moister as a result of the composting process, this warm and moist air can be extracted from the heap 16 by switching the aerating means to exhaust or extraction. This warmed and moistened air can be combined as required with fresh air from the air inlet 32 to control air temperature and moisture levels of air distributed into the chamber 22 and through the aeration bed 12. Combining of recovered and fresh air can be controlled by suitable means such as by one or more butterfly valves. For example if the valve is closed, the aerating means will introduce only fresh air, drawn externally from the heap 16, into the chamber 22. If the valve is open, then the aerating means will introduce substantially equal parts of fresh air and air recovered from the heap 16 into the chamber 22. Such air is likely to be warmer and moister than externally sourced air, thereby contributing to increase of temperature and/or moisture in the heap 16.

Ratio of fresh and recovered air can be modified automatically as necessary in order to maintain conditions, particularly temperature and oxygen levels at optimum for the composting process. Ratio is modified in response to fluctuations in temperature and oxygen within the heap and surrounding area of the holding area 14. Temperature and oxygen is monitored by appropriate monitoring means, such as temperature probe and/or oxygen analyser, which communicate monitored data to data processing unit. Data processing unit in turn communicates with controller which acts to control valve and/or blower to modify ratio of fresh and recovered air to meet immediate needs and maintain optimal composting conditions throughout the entire process.

The aerating means may therefor provide a variable controllable proportion of recycled air, channelled from the heap, and fresh air, assisting in maintaining the moisture levels and temperature of the heap, thereby preventing drying out of compost and maintaining substantially the entirety of the heap at a temperature ideal for composting microbial activity, typically about 50-65° C.

The composting system 10 of the present invention therefore provides a system having improved air distribution throughout the heap 16, thereby facilitating composting at substantially the same rate throughout the heap. The present system also facilitates greater control and capacity for manipulation of air temperature and moisture, thereby conferring ability to modify heap conditions to suit a particular stage of the composting process. Advantageously, use of the compost system of the present invention as described can halve the total time taken to achieve a mature composted product, primarily due to the improved distribution of air throughout the heap.

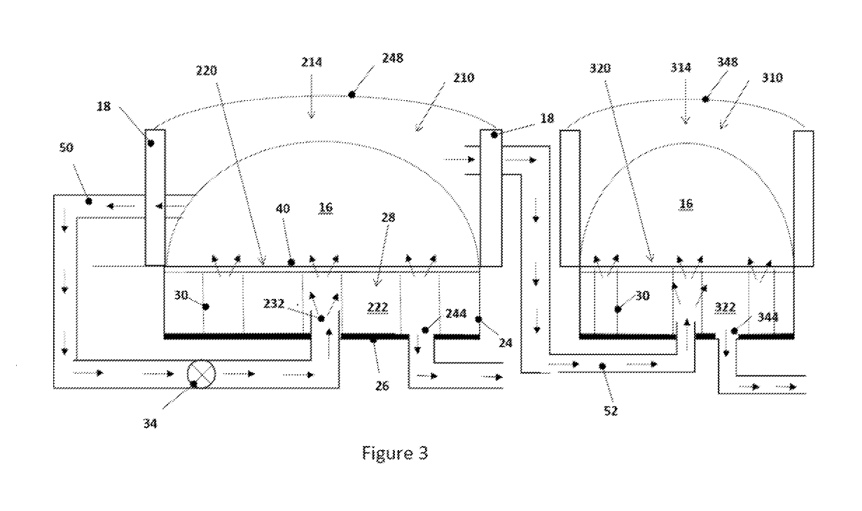

Referring now to FIG. 3, there is shown a further embodiment of the present invention wherein the composting system 10 includes a first treatment zone 210 and a second treatment zone 310. The first treatment zone 210 includes holding area 214 having permeable base; at least one chamber 222 located below the holding area 214 and permeable base 220; inlet 232 to direct oxygen containing fluid, typically a gas, into the chamber 222 and outlet 244. An aerating means or air supply system for providing and directing oxygen-containing gas to the inlet and chamber is also provided. The second treatment zone 310 has the same features, and both first and second treatment zones 210, 310 have features substantially the same as those described above with respect to the first embodiment and where like numerals denote same/similar features.

In this embodiment, compostable material is treated in a first treatment phase in the first treatment zone 210 by aerating the heap of compostable material substantially as described above. That is, the heap of compostable material is aerated and temperature/moisture controlled as necessary. The duration of the first treatment phase is determined at least in part by the type, nature and/or composition of the compostable material. Typically, the first treatment phase continues for approximately four weeks.

At the end of the duration of the first treatment phase, the end of which may be determined by the compostable material attaining predetermined characteristics and/or composition, the compostable material is transferred to the holding area 314 of the second treatment zone 310. The compostable material is subject to a second treatment phase, the duration of which is again determined at least in part by the nature, type and/or composition of the compostable material. The second treatment phase is typically around two weeks in duration.

The second treatment phase similarly includes aeration of the compostable material by creating a positive pressure within the chamber 322 and directing air upwardly through the permeable base 320 and into and throughout the heap of compostable material. The second treatment zone 310 is in fluid communication with the first treatment zone 210 such that spent air, being air that has already passed through the heap in the first treatment zone 210 i.e. recycled air, can be directed into the chamber 322 of the second treatment zone 310 and into the compostable material.

Spent air can be channelled into the chamber 322 by suitable means, such as a conduit 52. The compostable material in the second treatment zone 310 can be aerated solely with this spent air or can be blended with fresh air introduced into the chamber 322 by aeration means. Ratio of spent/fresh air can be varied as necessary by control means and this can include one or more butterfly valves, substantially as described above with reference to the first embodiment.

Advantageously, utilisation of the spent air from the first treatment zone 210 not only provides a source of air for treating the compostable material in the second treatment zone 310, but it acts to condition the spent air. That is, the action of channelling spent air from the first treatment phase removes odorous compounds from the air by the action of passing through the compostable material in the holding area 314. The compostable material in holding area 314 effectively acts as a filter to remove odour and render the air suitable for release into the environment. The treated air, having passed through the compostable material in the second treatment phase, can be expelled via pipe, conduit or other suitable means.

Any liquid that seeps from the compostable material in holding area 314, through permeable base 320 and into chamber 322 can be removed via outlet 344. Outlet 344, as in the first embodiment and in the first treatment zone 210 of the second embodiment, is located lower than the inlet 332 to avoid any liquid draining into the inlet 332 and affecting aeration system. Ideally, the outlet 344 is disposed in base of the chamber 322. Liquid is drained via outlet 344 and into appropriate drainage system for discharge or storage.

It will be appreciated that the system described above finds advantageous and useful application in composting of organic material. However, the system and features of the system can advantageously find application in other, unrelated functions. Since the present system facilitates even distribution of temperature and air through a static heap of material, these capabilities can be utilised in applications such as drying of bulk quantities of grain. These sorts of applications can be undertaken without significant modification of the present system.

1. A composting system including:
a) a holding area for holding a quantity of compostable material, the holding area having a base with at least one permeable portion;
b) at least one chamber located below the holding area;
c) an inlet to direct oxygen-containing fluid into the chamber; and
d) an outlet for directing matter outwardly from the chamber, wherein an opening of the outlet is disposed lower in the chamber relative to an opening of the inlet.

2. The system of claim 1, including an air supply system to provide a positive air pressure into the chamber.

3. The system of claim 2, wherein the air supply system provides a positive air pressure into the compostable material through the permeable base.

4. The system of claim 2, wherein the air supply system includes a blower to provide the positive air pressure.

5. The system of claim 2, wherein the air supply system includes an air distribution system providing airflow into two or more inlets opening into the chamber.

6. The system of claim 2, wherein the air supply system includes a return airflow passage from the compostable material back into the chamber.

7. The system of claim 1, wherein the base, or each permeable portion of the permeable base, includes at least one mesh below the compostable material.

8. The system of claim 7, wherein the at least one permeable portion of the base includes a first mesh portion and a second mesh portion, the first mesh portion having apertures of a size sufficient to hold a substantial portion of the compostable material atop the base and the second mesh portion has apertures of size smaller relative to aperture size of the first mesh portion.

9. The system of claim 8, wherein apertures of the second mesh portion are of a size sufficient to permit flow of liquid and prevent smaller solid particles from passing into the chamber.

10. The system of claim 8, wherein apertures of the second mesh portion are greater than about 105 microns.

11. The system of claim 8, wherein the first mesh portion overlays the second mesh portion.

12. A method of aerating a compostable material, the method including providing a supply of a gas at a pressure above ambient air pressure into a compostable material.

13. The method of claim 12, wherein the gas includes or is air.

14. The method of claim 12, wherein the gas is supplied into a chamber below the compostable material and allowed to travel up into the compostable material.

15. The method of claim 12, including returning gas from the compostable material back into the supply to the compostable material.

16. The method of claim 12, including controlling temperature within at least one zone within the compostable material by controlling at least one of rate or volume of gas flow through the compostable material, rate or volume of gas flow from and returned to the gas supply, and rate or volume of gas supplied to the compostable material.

17. The method of claim 16, wherein the gas flow is controlled by varying rate or volume of gas supplied for a blower into the chamber and/or varying gas returned to the chamber or compostable material.

18. The system according to claim 1, further comprising a second holding area for holding a quantity of compostable material, the second holding area having:
a) a base with at least one permeable portion;
b) at least one chamber located below the second holding area;
c) an inlet to direct a fluid into the chamber; and
d) an outlet for directing matter outwardly from the chamber.

19. The system of claim 18, wherein fluid directed into the chamber through the inlet includes one or more of fresh air or air recovered from the first holding area.

20. The system of claim 18, wherein ratio of fresh and recovered air is controlled by control means.

21. The system of claim 18, wherein ratio of fresh and recovered air is controlled with reference to parameters of temperature and/or oxygen content.
